(19) United States
(12) Patent Application Publication
(10) Pub. No.: US 2004/0011091 A1
(43) Pub. Date: Jan. 22, 2004

(54) Snowboard lock

(76) Inventor: Marcus John Zeuschner, Newport (AU)

Correspondence Address: Andrus Sceales Starke & Sawall, Suite 1100, 100 East Wisconsin Avenue, Milwauke, WI, 53202-4178, US

(21) Appl. No.: 10/297,028

(22) PCT Filed: May 31, 2001
(86) PCT No.: PCT/AU01/00647

(30) Foreign Application Priority Data
May 31, 2000 (AU) PQ 7882

(51) Int. Cl. E05B 73/00; E05B 13/00

(52) U.S. Cl. 70/19; 70/210

(57) ABSTRACT

A security lock device for portable sporting articles such as skis, snowboards and the like has opposed jaws (10, 11) for clamping onto an edge of the article. One of the jaws has barbs (28) projecting from a face of the jaw for penetrating slightly into the article and preventing removal therefrom when clamped in position. A lever arm (15) mounted for pivotal movement on a first jaw (10) supports a bolt (13) which is pivotally connected to the lever arm (15) and extends through a bore in a second jaw (11). A nut (12) on said bolt retains the second jaw (11) on the bolt (13) in an adjustable manner whereby the spacing between the jaws (10, 11) can be varied. Actuation of the lever (15) from an open to a closed position draws the jaws (10, 11) towards each other to clamp onto the article and a security locking mechanism (38) locks the lever arm (15) in a closed position within a cavity of the first jaw (10). When the device is clamped onto the edge of a ski or snowboard the article is unable to be used effectively.

The present invention relates to a lock device for securing sporting equipment against unauthorised use of theft and whilst in one form it may be used with many different portable articles of sporting equipment it is primarily intended for use with snowboards, snow skis and the like articles.

Articles such as snow skis and snowboards are highly portable and because of their streamline features do not have any convenient protruding parts or apertures which can be used as an anchoring or locating point for a locking chain or the like. Therefore, such articles are difficult to secure against unauthorised use and if left unattended are also susceptible to theft.

Accordingly, it is an object of this invention to provide a lock devise for rendering portable sporting equipment, particularly skis unusable or unattractive to thieves.

The invention therefore provides a lock device having opposed jaws adapted for movement towards and away from each other whereby said device may be clamped onto a part of an article, at least one of said jaws having one or more barbs projecting from a face of the jaw to engage said article when said device is clamped thereto and a security lock for locking said jaws in said clamped condition.

In a preferred form, said device is clamped over the edge of a ski or snowboard and thereby renders the article unusable.

Preferably there are a plurality of said barbs arranged in respective slots in said face, the shape of the barbs and the respective slots being such that any forced movement of said device in an attempt to slide it off the edge of said ski or snowboard causes a force to be applied to said barbs resulting in a further engagement force between said barbs and said article.

In order that the invention may be more readily understood a particular embodiment will now be described with reference to the accompanying drawings wherein:

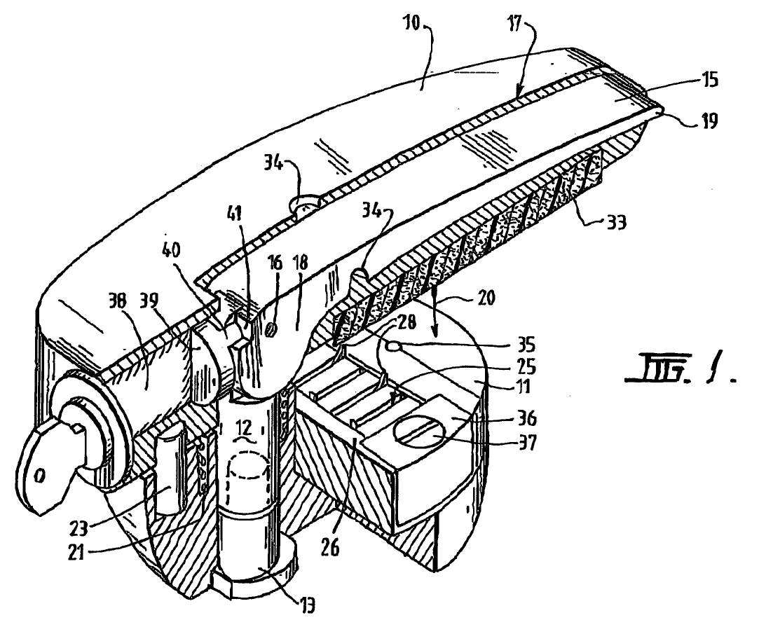

FIG. 1 is a perspective view, in section, of a lock device according to the invention;

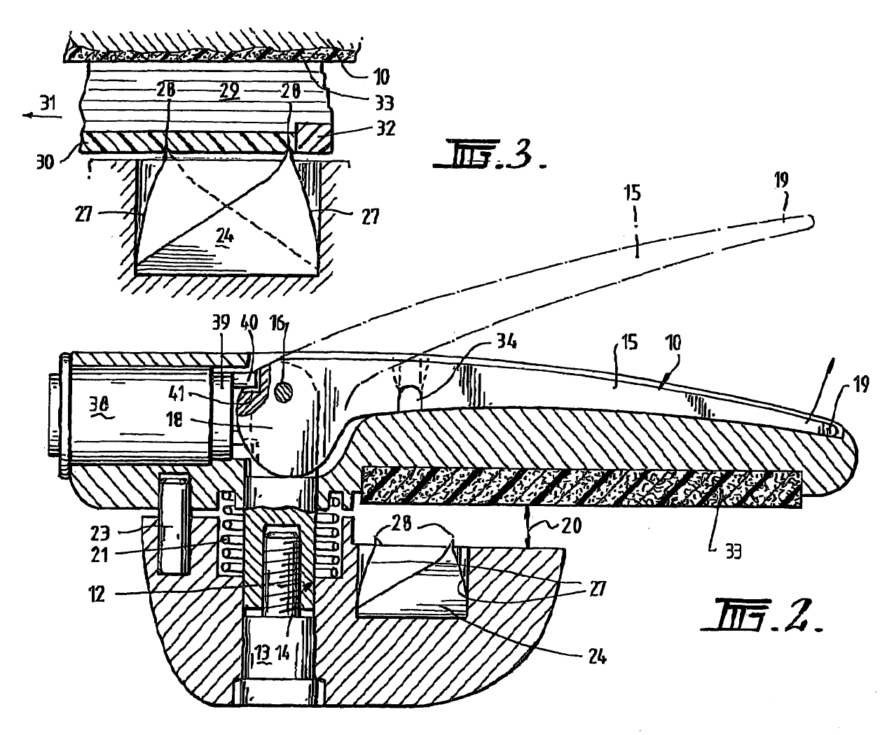

FIG. 2 is a sectional side elevation of the lock device of FIG. 1;

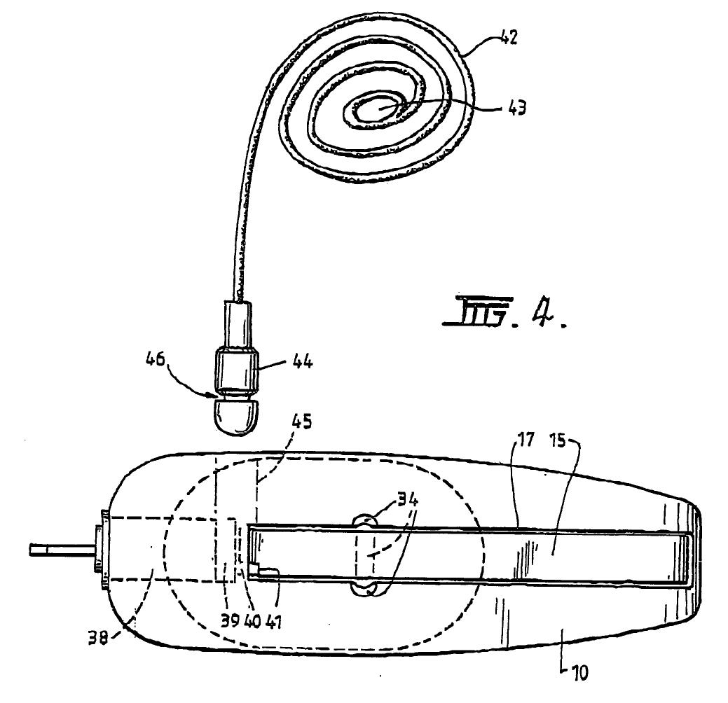

FIG. 3 is an enlarged view of part of the jaws of the device of FIGS. 1 and 2, shown in engagement with an edge of a snowboard; and

FIG. 4 is a plan view of the device show in FIGS. 1 and 2 showing a security cord or chain attachment for the device.

The lock device of this embodiment consists essentially of two parts being a first jaw member 10 and a second jaw member 11. The jaw members are connected together essentially by a bolt 13 and nut 12 which extend through a suitable hole 14 in the second jaw member 11. The nut 12 is pivotally connected to a lever arm 15 by means of pivot pin 16 and the lever arm 15 is accommodated in a suitable recess 17 in the fist jaw member 10.

The recess 17 is shaped substantially complementary to the lever arm 15 so that in a first or closed position of th lever arm 15, it is fully accommodated in the recess 17 such that the outer face of the lever arm 15 is substantially flush with the outer surface of the first jaw member 10. A cam-shaped boss 18 at the pivot end of the lever arm 15 is accommodated in the recess 17 in a manner such that lifting the free end 19 of the lever arm causes the lever arm to pivot on the boss 18. In the closed position of the lever arm 15 the pivot pin 16 is in its furthest position away from the second jaw member 11. The result is that in the closed position of the lever arm 15, the nut 12 and bolt 13 pull the second jaw member 11 towards the first jaw member 10 and the gap 20 between the jaw members when the lever arm 15 is closed is determined by adjustment of the bolt 13 on the nut 12. In other words, the gap between the jaw member 10 and 11 in the closed position may be adjusted by means of the bolt 13 on the nut 12.

A spring 21 applies a force urging the jaw members 10 and 11 apart so that a force is applied by the second jaw member 11 against the bolt 13. In order to adjust the position of bolt 13 on nut 12, it is necessary to force the jaw members together against the force of spring 21 until the bolt 13 is clear of a recess in which it is located in the second jaw member 11 thus allowing the bolt to be turned.

Lifting the free end 19 of lever arm 15 causes the lever arm to pivot on boss 18 whereby the pivotal connection between the nut 12 and lever arm 15 moves towards the second jaw member 11. This causes the gap between the jaw members 10 and 11 to open under the force of spring 21. The position of lever arm 15 in the open position of the jaw members is shown by broken lines in FIG. 2.

A pin 23 is located in aligned recesses in the first and second jaw members in order to prevent pivotal movement between the jaw members about the axis of bolt 13. The second jaw member 11 is provided with barbs 24 which project the face of the jaw member 11 to penetrate slightly into the surface of an article clamped between the respective jaw members. As is evident in FIGS. 2 and 3 the barbs 24 are located in slots 25 in a housing 26 located in the jaw member 11. The barbs 24 are spaced transversely across the second jaw member 11 and are in staggered relationship. Each barb is essentially a triangular shaped plate having a curved side 27 at the end of which is a tooth 28 for penetrating the surface of an article. The housing 26 is positioned within the second jaw member 11 by being located in a machined slot and is precisely located in the machined slot by locking pin 35. The housing 26 is retained therein by means of end plates 36 and screws 37 which fasten the respective end plates to the second jaw member 11.

FIG. 3 shows an edge 29 of a snowboard clamped between the jaw members 10 and 11 with the barbs 24, or more specifically, the tooth 28 of each barb, penetrating a plastic base 30 of the snowboard. Any force in the direction of arrow 31 causes each tooth 28 to be forced in a direction to further penetrate the plastic base 30. This is due to the reaction between the curved side 27 of a barb 24 and the complementary curved surface of the housing 26. A steel edge 32 on the snowboard further prevents the teeth 28 releasing from the snowboard by sliding motion which may occur.

The first jaw member 10 is provided with a non-metallic pad 33 which prevents the first jaw member 10 damaging or at least marking the upper surface of a ski, snowboard or like product on which the locking device is used. The first jaw member 10 and the lever arm 15 are provided with an aligned groove 34 for purposes which will become apparent herein below.

In order to provide security against removal of the lock device from an article to which it is attached, such as a ski, snowboard, or the like, a security lock 38 is provided in the first jaw member 10. The security lock 38 acts upon the lever arm 15 such that in a locked position the lever arm 15 is unable to be moved from the closed or locked position shown in FIG. 1. In the present embodiment, the security lock 38 is a tumbler key-lock but it may equally be a dial type combination set with the dials being accessible from the outer surface of the first jaw member 10. The security lock 38 acts with a catch member 39 and causes the catch member to either bear on the lever arm 15 preventing movement thereof or, in an unlocked position, remain clear of the lever arm whereby it may be raised to release the jaw members 10 and 11 from an article to which they are clamped. The catch member 39 is essentially a disc having a protrusion 40 which is located within a stepped notch 41 in the boss 18 of the lever arm 15 or is clear of the step notch 41 when in the unlocked position.

As will be apparent from the above, the lock device described thus far is able to be clamped onto the edge of a ski or snowboard or like article and once in the locked position is unable to be forcibly removed. Because it is located on an edge of the ski or snowboard it prevents use of the article as it would interfere with the effective operation of the ski or snowboard. Therefore, theft of the article is unlikely because the article is unusable. If, however, further security against theft is desired, an accessory is provided in order to attach the lock device and consequently any article to which it is fixed, to a permanent structure such as a pole or other fixed structure around which a cord or chain may be affixed.

The accessory device comprises a cord or chain 42 having a loop 43 at one end and a plug member 44 securely attached to the cord or chain at the other end. The plug member 44 is adapted for insertion into a socket 45 arranged in the side of the first jaw member 10 and is adapted for locking within the socket 45 when the security lock 38 is in the locked position. As will be evident the cord or chain 42 may be secured around a pole, for example, by passing the cord or chain around the pole and inserting the plug member 44 through the loop 43. The plug member is then inserted in socket 45 in the lock device and is secured therein once the security lock 38 is in the locked position. For this purpose the plug member 44 is provided with an annular groove 46 which receives a further protrusion (not shown), on the catch member 39. This prevents removal of the plug member 44 when the security lock is in the locked condition.

As an alternative for using the accessory device it may be attached to a pole or like structure as described above but instead of inserting the plug member 44 into a socket in the first jaw member, the cord or chain may be passed through the groove 34 in the first jaw member and lever arm whereby the cord or chain can only be removed by sliding it longitudinally until it is withdrawn from the groove. The plug member 44 of course will prevent complete removal of the cord or chain from the groove 34 and therefore the cord or chain is attached to the lock device and the lock device is attached thereby to the pole or other permanent structure. The accessory device in either case allows the lock device to be attached in a locked condition to a permanent structure whereby any article to which it is attached is protected against theft.

As is apparent hereinabove the lock device of this embodiment attaches to a ski or snowboard or other article by clamping part of the article between the jaw members 10 and 11. The clamping force is achieved by means of lever arm 15 which moves the bolt 13 in an axial direction to pull the jaw members towards each other. Release of the lever arm 15 allows the jaw members to move apart slightly under the force of spring 21. Clearly, variations to the described embodiment could be readily envisaged by persons skilled in the art. For example, many other mechanisms could be used to draw the jaw members towards each other such as, for example, a screw clamp arrangement or a ratchet arrangement whereby the jaw members are pressed together to engage various steps in a ratchet arrangement. It is of course essential that the device be lockable in the clamped position.

The hostile environment in which a ski or snowboard is used will require the lock device to be manufactured from material able to withstand cold, ice, water, mud, etc. and should preferably be manufactured from high corrosion resistant material such as, for example, zinc alloys, magnesium alloys, stainless steel, titanium nitride coatings. Of course other suitable materials may be readily envisaged by persons skilled in the art.

Whilst the lock device has been described essentially for use in connection with skis or snowboards, it also provides a general purpose cable lock capable of securing backpacks, bikes and other products from theft or unauthorised use.

1. A lock device having opposed jaws adapted for movement towards and away from each other whereby said device may be clamped onto a part of an article, at least one of said jaws having one or more barbs projecting from a face of the jaw to engage said article when said device is clamped thereto, and a security lock for locking said jaws in said clamped condition.

2. A lock device as defined in claim 1 comprising a plurality of said barbs arranged in respective slots in said face, the shape of the barbs and the respective slots being such that any force applied to said device in an attempt to slide the device away from said article causes a further force to be applied to said barbs resulting in a further engagement force between said barbs and said article.

3. A lock device as defined in claim 2 comprising a lever arm mounted for pivotal movement in a first of said opposed jaws, and being connected to a second of said opposed jaws in a manner whereby pivotal movement of said lever arm to a closed position causes said jaws to move towards each other and pivotal movement of said lever arm to an open position allows said jaws to move away from each other, said jaws being spring biased away from each other.

4. A lock device as defined in claim 3, wherein said barbs comprise substantially triangular shaped plates having one side curved slightly outwardly and a tooth at one end of said curved side, said tooth projecting from said face to engage said article, each said slot having curved ends complementary to the curved side of a barb whereby one or the other of said curved ends engages the curved side of a barb to apply said further force to a barb when said first-mentioned force is applied to said device.

5. A lock device is defined in claim 4 wherein said slots are arranged in mutually parallel relationship in said face, the tooth of adjacent barbs being at opposite ends of said slots.

6. A lock device as defined in cain 5 wherein said lever arm is accommodated in a cavity in said first jaw when said lever arm is in said closed position and said security lock is adapted, in a locked position to prevent movement of said lever arm away from said closed position.

7. A lock device as defined in claim 6, wherein said lever arm is connected to said second jaw by a bolt and nut arrangement, said bolt being pivotally connected to said lever arm at a point such that pivotal movement of said lever arm causes axial movement of said bolt, and said nut bearing on said second jaw to cause movement of said jaws towards each other in one direction of said axial movement caused by movement of said lever arm to said closed position.

8. A lock device as defined in claim 7, wherein said nut is adjustable on said bolt, when said jaws are in a non-clamped position, to vary the gap between said jaws, said nut being captured in a cavity in said second jaw to prevent said adjustment other than when said jaws are manually forced towards each other against said spring bias to release said nut from said cavity in said second jaw.

9. A lock device as defined in claim 8 comprising a transverse groove in the lever arm for retaining a cord or chain between an underside of the lever arm and the first jaw whereby the cord or chain cannot escape the transverse groove other than by being withdrawn longitudinally and said cord or chain having a loop in one end and a fixed plug at the other end, said plug being too large to pass through said transverse groove.

10. A lock device as defined in claim 8, further including an accessory in the form of a cord or chain having a loop in one end and a fixed plug at the other end, said plug being adapted for retention in a cavity of said first jaw and being locked therein when said lever arm is in said closed position.

11. A lock device as defined in any one of the preceding claims wherein said security look comprises a tumbler key-lock or a dial type combination set, said security lock operating a catch mechanism which in a locked position bears on said lever arm to prevent movement of said lever arm from said closed position.
